(19) United States
(12) Patent Application Publication
(10) Pub. No.: US 2010/0304349 A1
(43) Pub. Date: Dec. 2, 2010

(54) INTERACTIVE MULTI-FUNCTIONAL GPS SYSTEM

(76) Inventor: Dina Kunin, Minneapolis, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/475,119

(22) Filed: May 29, 2009

(51) Int. Cl. G09B 7/00

(52) U.S. Cl. 434/323

(57) ABSTRACT

In some embodiments, an interactive learning apparatus may include one or more of the following features: (a) a network disposed in a vehicle to enable communications between various devices in the vehicle, (b) a GPS device operably coupled to the network, (c) a computer operably coupled to the network wherein the computer is adapted to control execution of interactive learning program based upon input from the GPS device, (d) an existing vehicle electronics device for the purpose of supporting the interactive learning program, (e) a network interface coupled to the computer for interfacing with the network, (f) a user interface coupled to the network, (g) a memory for storing code executable by the computer, the code supporting play of one or more interactive GPS learning program, and (h) an interactive learning server coupled to the network for supporting play of one or more interactive learning programs.

### I. FIELD OF THE INVENTION

Embodiments of the present invention generally relate to interactive game systems. Particularly, embodiments of the present invention relate to interactive multi-functional game systems. More particularly, embodiments of the present invention relate to interactive multi-functional game systems for use with global positioning in vehicles.

### II. BACKGROUND

A video game is an electronic game involving interaction with a user interface to generate visual feedback on a video device. The word “video” in video game traditionally referred to a raster display device. However, with the popular use of the term “video game”, it now implies any type of display device. The electronic systems used to play video games are known as platforms; examples of these are personal computers and video game consoles. These platforms are broad in range, from large computers to small handheld devices. Specialized video games such as arcade games, while previously common, have gradually declined in use.

The input device normally used to manipulate video games is called a game controller, which varies across platforms. For instance, a dedicated console controller might consist of only a button and a joystick, or feature a dozen buttons and one or more joysticks. Early personal computer based games historically relied on the availability of a keyboard for gameplay, or more commonly, required the user to purchase a separate joystick with at least one button to play. Many modern computer games allow the player to use a keyboard and mouse simultaneously.

Beyond the common element of visual feedback, video games have utilized other systems to provide interaction and information to the player. Chief examples of these are sound reproduction devices, such as speakers and headphones, and an array of haptic peripherals, such as vibration force feedback.

The term “platform” refers to the specific combination of electronic or computer hardware which, in conjunction with low-level software which allows a video game to operate. The term “system” is also commonly used. In common use a “PC game” refers to a form of media involving a player interacting with a personal computer connected to a high-resolution video monitor. A “console game” is played on a specialized electronic device connecting to a standard television set or composite video monitor. A “handheld” interactive learning device is a self contained electronic portable device and can be held in a user's hands. “Arcade game” generally refers to a game played on an even more specialized type of electronic device typically designed to play only one game and is encased in a special cabinet. These distinctions are not always clear and there may be games bridging one or more platforms. Beyond this there are platforms having non-video game variations such as in the case of electro-mechanically based arcade machines. There are also devices with screens which have the ability to play games but are not dedicated video game machines (examples are mobile phones, personal data assistants and graphing calculators).

It has been shown action video game players have better visuomotor skills, such as their resistance to distraction, their sensitivity to information in peripheral vision, and their ability to count briefly presented objects than non-players. They found such enhanced abilities could be acquired by training with an action game, involving challenges to switch attention to different locations, but not with a game requiring concentration on single objects. It has been suggested by a few studies online/offline video interactive learning can be used as a therapeutic tool in the treatment of different mental health concerns.

Some have argued video games in fact demand far more from a player than traditional games like Monopoly. To experience the game, the player must first determine the objectives, as well as how to complete them. They must then learn the game controls and how the human-machine interface works, including menus and HUDs (heads up displays). Beyond such skills, which after some time become quite fundamental and are taken for granted by many gamers, video games are based upon the player navigating (and eventually mastering) a highly complex system with many variables. This requires a strong analytical ability, as well as flexibility and adaptability. The process of learning the boundaries, goals, and controls of a given game is often a highly demanding one calling on many different areas of cognitive function. Indeed, most games require a great deal of patience and focus from the player, and, contrary to the popular perception games provide instant gratification, games actually delay gratification far longer than other forms of entertainment such as film or even many books. Some research suggests video games may even increase players' attention capacities.

Learning principles found in video games have been identified as possible techniques with which to reform the United States education system. It has been noticed garners adopt an attitude while playing of such high concentration; they don't realize they're learning and if the same attitude could be adopted at school, education would enjoy significant benefits. Students are found to be “learning by doing” while playing video games and fostering creative thinking.

The U.S. Army has deployed machines such as the PackBot which makes use of a game-style hand controller intended to make it more familiar to use by young people.

According to research discussed at the 2008 Convention of the American Psychological Association, certain types of video games can improve the gamers' dexterity as well as their ability to problem-solve. A study of 33 laparoscopic surgeons found those who played video games were 27 percent faster at advanced surgical procedures and made 37 percent fewer errors compared to those who did not play video games. A second study of 303 laparoscopic surgeons (82 percent men; 18 percent women) also showed surgeons who played video games requiring spatial skills and hand dexterity and then performed a drill testing these skills were significantly faster at their first attempt and across all 10 trials than the surgeons who did not play the video games first.

Whilst many studies have detected superior mental aptitudes amongst habitual gamers, research by Walter Boot at the University of Illinois found non-gamers showed no improvement in memory or multitasking abilities after 20 hours of playing three different games. The researchers suggested “individuals with superior abilities are more likely to choose video interactive learning as an activity in the first place”.

A GPS navigation device is any device receiving Global Positioning System (GPS) signals for the function of determining the present location. These devices are used in military, aviation, marine and consumer product applications. An automotive navigation system is a satellite navigation system designed for use in automobiles. It typically uses a GPS navigation device to acquire position data to locate the user on a road in the unit's map database. Using the road database, the unit can give directions to other locations along roads also in its database. Dead reckoning using distance data from sensors attached to the drivetrain, a gyroscope and an accelerometer can be used for greater reliability, as GPS signal loss and/or multipath can occur due to urban canyons or tunnels.

It would be desirable to have an interactive multi-functional game for a vehicle. It would be desirable if this game could be used by children to teach them about their surroundings as they travel. It would be desirable for the interactive game system to be coupled to a GPS system to interact with a child during travel to point out historic sites, rules of the road, colors of road signs, geography, math, history, vocabulary/spelling, science and many other aspects of their surroundings. It would be desirable to have an interactive multi-functional GPS system which could be controlled by the operator of the vehicle. It would be desirable to have an interactive multi-functional GPS system which could be controlled by voice activated wireless technology. It would be desirable to have multiple independent interactive multi-functional GPS units throughout a vehicle. It would be desirable to create a positive learning experience with animated character adventures with different scope of learning according to skill level and preference.

### III. SUMMARY OF THE INVENTION

In some embodiments, an interactive learning apparatus may include one or more of the following features: (a) a network disposed in a vehicle to enable communications between various devices in the vehicle, (b) a GPS device operably coupled to the network, (c) a computer operably coupled to the network wherein the computer is adapted to control execution of interactive learning program based upon input from the GPS device, (d) an existing vehicle electronics device for the purpose of supporting the interactive learning program, (e) a network interface coupled to the computer for interfacing with the network, (f) a user interface coupled to the network, (g) a memory for storing code executable by the computer, the code supporting play of one or more interactive GPS learning program, (h) an interactive learning server coupled to the network for supporting play of one or more interactive learning programs, and (i) a display device coupled to the network for displaying interactive learning GPS program information to a vehicle occupant.

In some embodiments, an interactive learning apparatus for use in a vehicle may include one or more of the following features: (a) a network disposed in a vehicle to enable communications between various devices in the vehicle, (b) a GPS unit operably coupled to the network for providing vehicle positioning data to various devices in the vehicle, (c) a computer operably coupled to the network which can receive GPS data and based upon this data implements interactive learning programs for a vehicle user, (d) a display device coupled to the network for displaying interactive learning program information to a vehicle occupant in accordance with GPS location data provided by the GPS unit, (e) existing consumer electronics device coupled to the network wherein the consumer electronics device is configured to function as a interactive learning platform to support GPS interactive learning program, (f) a network interface for interfacing the computer with the network, (g) a user interface coupled to the network, (h) a memory, coupled to the computer, for storing code executable by the computer and for storing at least temporarily one or more interactive learning programs, and (i) a multifunction controller for transmitting control information to the computer via the network to permit a vehicle occupant to interact with the interactive GPS learning program. In some embodiments, a method for interactive learning in a vehicle may include one or more of the following steps: (a) using a network disposed in a vehicle to enable communications between various electronic devices in the vehicle, (b) receiving GPS data from a GPS device, (c) processing an interactive learning program based upon received GPS data, (d) displaying the interactive learning program to a vehicle occupant, (e) receiving commands from the vehicle occupant directing the interactive learning program, (f) adapting one of the electronic devices to support interactive GPS learning programs, (g) displaying a menu including interactive GPS learning options to a vehicle occupant, (h) receiving over the network at the selected menu option; if the selected menu option is an interactive GPS learning program, providing the interactive learning program selection to the vehicle occupant, (i) downloading an interactive GPS learning file corresponding to the interactive GPS learning selection over the network, and (j) executing executable code in a computer in order to run the selected interactive GPS learning program corresponding to an inputted GPS location of the vehicle.

### IV. DESCRIPTION OF THE DRAWINGS

FIG. 1 shows a block diagram of the internal architecture of a computing device according to some embodiments of the invention;

FIG. 2 shows an interactive GPS vehicle-based learning system for kids in an embodiment of the present invention;

FIG. 3 shows a functional block diagram of an interactive GPS vehicle-based learning system for kids in an embodiment of the present invention;

FIG. 4 shows a flow chart diagram for selecting and running an interactive GPS learning system in an embodiment of the present invention; and

FIG. 5 shows a flow chart diagram for using an interactive GPS learning system in an embodiment of the present invention.

### V. DESCRIPTION OF THE PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention disclose an interactive multi-functional software/hardware designed to be used with a car GPS system. It can be a feature integrated into a GPS system in a vehicle or stand alone GPS. An SD/MMC (secure digital multi-media card) could be used to upload the software. There could be a main unit as well as additional terminals. The main unit could be located by the driver; the additional units can be either attached to the headrest of the front seats, or can be hand held with wireless capabilities. These additional units can also be touch screen. The main unit can use wireless voice activated technology while displaying standard GPS functions. The additional units although connected to the main unit, do not have to have the same exact display. While the car is in motion, the animated GPS display for the additional units can be used together with the GPS system to integrate navigation while focusing on multi-functional entertainment. The function of the software is to create a positive learning experience by infusing animated character adventures with different areas of learning according to skill level and preference. This software integrates interactive activities with the standard functions of a GPS system such as: driving rules, dynamics of the road, geography, math, history, vocabulary/spelling and science. This multi-functional feature can be turned off if not used.

GPS systems have become standard on most new vehicles. While the GPS technology has become very advanced in terms of directional capabilities, preloaded maps, points of interest, wireless transmit ion and picture viewers the focus has not shifted beyond the main capabilities of the system. A voice feature can allow minimal interaction and is used typically when asked a question. There are many times during a drive where there is silence. The GPS does not interact with the users on any other level besides navigation. Embodiments of the present invention focus on using the GPS to educate and entertain children and adults while driving.

There are a few accessories which can be purchased for a GPS system. For example, a five language dictionary, where you can input a word or phrase for translation, as well as audio books. You can also listen to music using a built in MP3 player. Past solutions have not shifted the focus from standard GPS functions. In order to utilize the GPS system to its full potential, embodiments of the present invention focus on incorporating education and entertainment. Instead of standard entertainment like music and movies, the occupants of a vehicle can learn and be entertained at the same time.

Therefore, embodiments of the present invention disclose a vehicle GPS system software with all advancements related to the main GPS function. The present invention can use touch screen and wireless technology. The software can be interactive for education and entertainment. The system displays different information, although still GPS related. The additional units allow user interaction, education and entertainment. The activities range from basic knowledge of driving rules and road dynamics to geography.

FIG. 1 is a representative block diagram of a computing device according to some embodiments. It is understood computing device 4 could be used to execute program 200 described below. Computing device 4 may comprise a single device or computer, a networked set or group of devices, or computers, such as a workstation, laptop, etc. Computing device 4 is typical of a data session-capable machine. Computing device 4 can include a microprocessor 30 in communication with communication bus 40. Microprocessor 30 is used to execute processor-executable process steps so as to control the components of computing device 4 to provide functionality according to embodiments of the present invention. Microprocessor 30 may comprise a Pentium™ or Itanium™ microprocessor manufactured by Intel™ Corporation. Other suitable processors may be available from Motorola™ Inc., AMD™, or Sun Microsystems™ Inc. Microprocessor 30 also may comprise one or more microprocessors, controllers, memories, caches and the like.

Input device 60 and display 70 are also in communication with communication bus 40. Any known input device may be used as input device 60, including a keyboard, mouse, touch pad, voice-recognition system or any combination of these devices. Input device 60 may be used by a user to input information and commands.

Display 70 may be an integral or separate CRT display, a flat-panel display or the like. Display 70 is generally used to output graphics and text to an operator in response to commands issued by microprocessor 30.

RAM (Random Access Memory) 80 is connected to communication bus 40 to provide microprocessor 30 with fast data storage and retrieval. In this regard, processor-executable process steps being executed by microprocessor 30 are typically stored temporarily in RAM 80 and executed therefrom by microprocessor 30. ROM (Read-Only Memory) 90, in contrast, may provide storage from which data can be retrieved but to which data cannot be stored. Accordingly, ROM 90 may be used to store invariant process steps and other data, such as basic input/output instructions and data used during system boot-up or to control input device 60. One or both of RAM 80 and ROM 90 may communicate directly with microprocessor 30 instead of over communication bus 40, or on separate dedicated busses.

Data storage device 95 stores, among other data, processor-executable process steps of program 200. The process steps and program code of program 200 and the like may be read from a computer-readable medium, such as a floppy disk, a CD-ROM, a DVD-ROM, a Zip™ disk, a magnetic tape or a signal encoding the process steps/program code and then stored in data storage device 95 in a raw, compressed, un-compiled and/or encrypted format. In alternative embodiments, hard-wired circuitry may be used in place of or in combination with processor-executable process steps for implementation of the processes described herein. Thus, embodiments are not limited to any specific combination of hardware, firmware and software.

Also illustrated is a network interface 50 which may be a wired or wireless Ethernet interface, a modem interface, etc. In utilizing the various embodiments of the invention, network interface 50 may be connected to or provide access to a high-speed connection to the Internet or an Intranet provider giving access to the Internet or similar networks. Using such a network or networks, computing device 4 can communicate identifiers of destination parties to a mobile application server.

Stored in data storage device 95 may also be other elements necessary for operation of computing device 4, such as other applications, other data files, a network server, an operating system, a database management system and “device drivers” for allowing microprocessor 30 to interface with external devices. These elements are known to those skilled in the art and are therefore not described in detail herein.

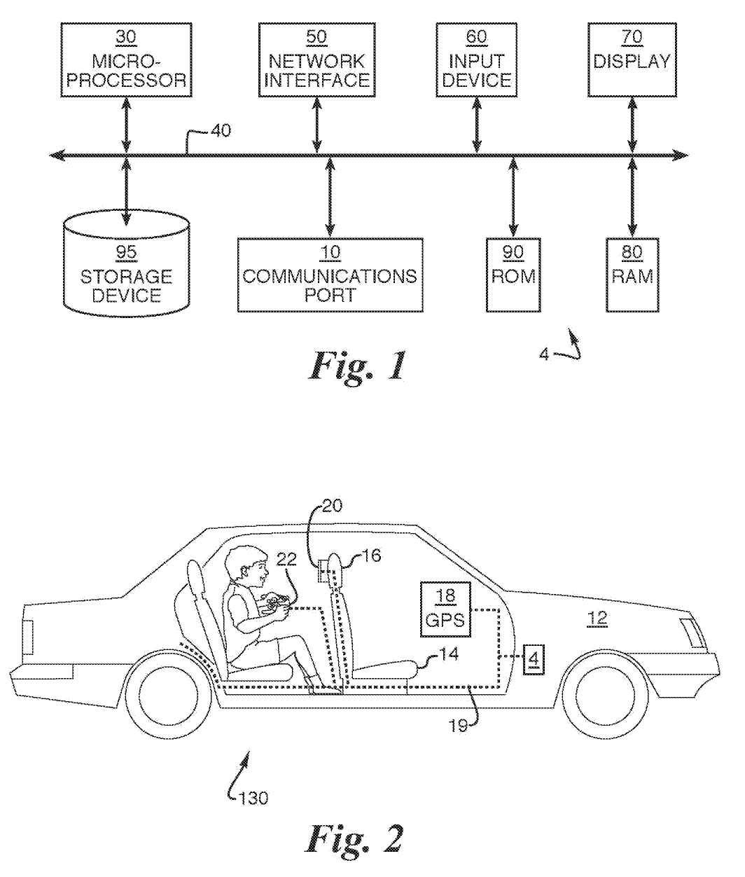

With reference to FIG. 2, an interactive GPS vehicle-based learning system for kids in an embodiment of the present invention is shown. An interactive GPS vehicle based learning system 130 in a vehicle 12 is shown. GPS learning system 130 can make use of some existing control, circuitry, wiring, sound system, display system, network, bus, or other infrastructure already installed in vehicle 12. GPS learning system 130 can use an existing GPS system 18 coupled to computing device 4. GPS system 18 is shown as being accessible to a car occupant in front seat 14 for operation by the driver or passenger next to the driver. GPS system 18 may be, for example, an existing GPS or a portable GPS device adapted to interface with network 19.

GPS system 18 is shown in this example coupled by any suitable signal connection to GPS game display 20. Signal communication may be by wire, glass fiber or wireless link. Network 19 simply indicates a signal connection without specifying a particular type or medium of connection. Wireless transmission has the advantage of eliminating the need for wiring installation but also requires the various communicating units have suitable wireless transceivers. But an air interface may also have some limitations which are not factors in a wired interface. As an example, network 19 can be an Ethernet-based local area network or a wireless network such as an IEEE 802.11 type wireless local area network.

For interactive learning, GPS system 18 can be configured to permit the driver (e.g., parent) to monitor, and if desired, select games for play by rear seat passengers (e.g., children) as well as other conditions such as volume, duration, etc. In other implementations, selections can be made by any car occupant using a controller, or using an integrated, multi-task controller. Computer 4 is coupled to memory 90, e.g., an interactive learning library, for storing multiple video learning programs with associated data. Computer 4 can be coupled to game display 20 via a video bus to provide interactive leaning video signals for interactive learning. But again, the interactive learning video may be delivered to display 20 via wire or wireless link.

One or more displays 20 may be mounted or otherwise accessible in the car for use by one or more passengers. While FIG. 2 shows only one display, it is fully contemplated any number of displays, within reason, could be used within vehicle 12. Each display 20 may be any type of display. One example is an LCD type of display with a wide angle of viewing, an anti-glare screen, and physically moveable or at least pivotable. Display 20 can be mounted in or on a head rest 16, but other locations may be desirable including in or on the seat back, an arm rest, from the car roof, on the car dash, handheld or elsewhere.

Interactive learning audio may be delivered from computer 4 to a car radio via an audio/video bus or by sound system speakers already situated in vehicle 12. Alternatively, earphone or headset jacks coupled to computer 4 may be located at or near each display 20 to permit individual passengers to listen to the interactive learning audio without disturbing others using individual earphones or headsets. Alternatively, each display 20 may include a speaker. The interactive learning audio may be delivered to the radio, speakers and earphone or headset jacks via wire or wireless link. Wireless headsets are also suitable.

Each passenger location associated with a display 20 has a controller 22 of some sort, e.g., a game or multifunction controller, with multiple buttons, switches and/or joystick(s). Controller 22 may be used to generate interactive learning select signals if interactive learning choices are displayed on a menu, to select other forms of entertainment such as radio, music, movies (if a DVD or VCR is provided in the car entertainment system), etc., and interactive learning play signals, e.g., moving objects across display 20. Again, game controller signals may be delivered via wire or wirelessly.

The interactive learning equipment is preferably hardened or sufficiently rugged to satisfactorily and reliably function in the extreme temperature and natural temperature swing, bumpy, vibratory and physically changing environment of a moving car. Standard consumer mass storage devices may be replaced with mass storage devices selected for extended environmental characteristics such as extended temperature and vibration range. However, storage device 95 is less susceptible to dysfunction in bumpy and vibratory environments. Flash memory may be used as a storage alternative.

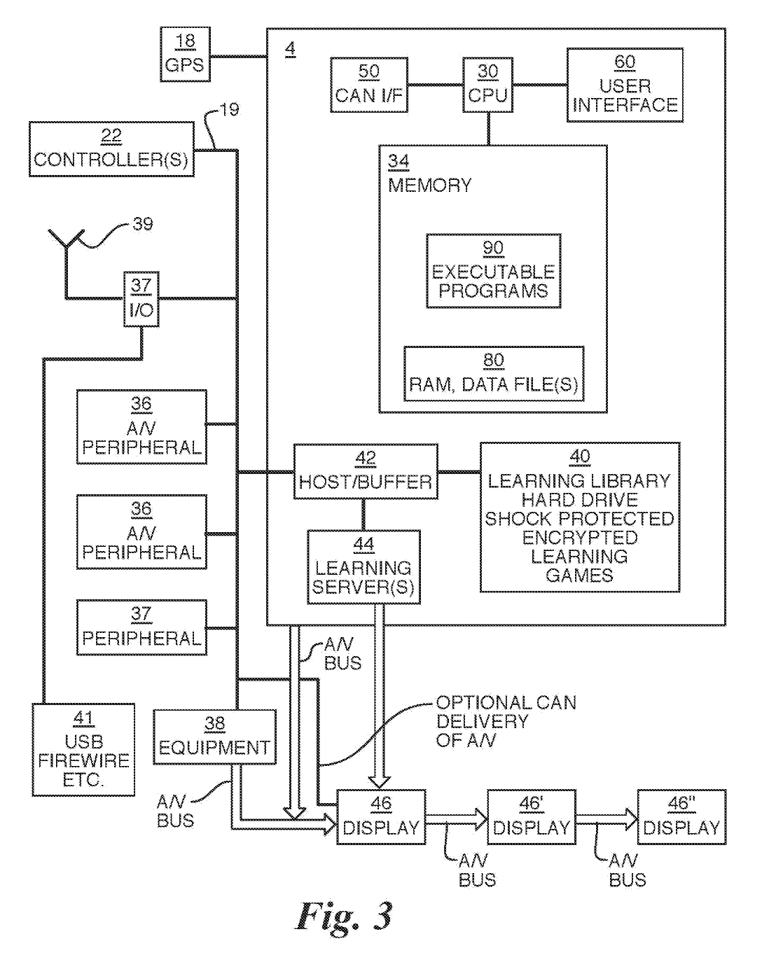

With reference to FIG. 3, a functional block diagram of an interactive GPS vehicle-based learning system for kids in an embodiment of the present invention is shown. Computer 4 already includes basic hardware, as discussed above, such as a central processing unit (CPU) 30 and related circuitry, memory 34, and a user interface 60, and basic software, such as an operating system and one or more applications such as program 200 discussed in detail below. Computer 4 can be adapted to include a network interface 50 coupled to processor 30 to permit computer 4 to communicate via network 19. Memory 34 may need to be expanded (or not depending on the memory already present in computer 4). In emulation embodiments, executable code such as one or more interactive learning platform emulators or one or more interactive learning transcompilers may be stored along with interactive learning data files used by the executable code to emulate a selected game.

Computer 4 can be coupled to one or more audio and/or visual (A/V) peripherals 36 and possibly to one or more other type(s) of peripherals 37 via network 19. Peripherals can include without limitation a DVD player, a MP3 player, a VCR, an audio cassette player, a sound system, a liquid crystal display (LCD) system, an interactive learning system already installed in the car, etc. A peripheral 37 may include a radio transceiver for communicating wirelessly via antenna 39 or other wired transceiver for communicating by a USB (Universal Serial Bus), FireWire 41 or other port. If wired, network 19 may be a high-speed, serial bus, (e.g., a USB), a parallel or other bus structure could be used.

Computer 4 may have associated equipment 38, e.g., a DVD changer and an audio/visual bus in the case where computer 4 is a DVD player, coupled to network 19. Computer 4 can perform all it's initially designed function plus perform interactive learning, and if desired, other car control functions via network 19. Audio generated by equipment 38 may be routed over the bus to drive speakers already in the car or may be routed to suitable earphone/headset jacks. Video generated by equipment 38 may be routed over an audio/video (A/V) bus to a display 46. An audio/video bus couples equipment 38 and the display 46.

Network 19, bus, or the like may already be installed by the vehicle manufacturer or an after-sale retailer. If there is network 19, bus, or the like installed in vehicle 12, then a wired bus could be installed or a wireless network 19 may be employed using available wireless LAN technology, e.g., IEEE 802.11. Each device coupled to network 19 has its own address or ID and includes a CAN I/F monitoring the data packets being transmitted over the network 19 to see if the data packet includes its address. If the packet matches its address, the device processes the packet; otherwise, the device ignores the packet. Any suitable protocol for network data communication may be used. For example, for wired network communications, the Ethernet protocol may be used, and for wireless, any version of IEEE 802.11 may be used. If a wireless network is used, then the devices must be able/adapted to communicate wirelessly. Standard wireless LAN cards may be used.

A host/buffer board 42 can be coupled to network 19 for receiving interactive learning selection instructions from computer 4. Host/buffer board 42 includes interface logic and one or more buffers and is coupled to one or more interactive learning server(s) 44. An interactive learning library 40 can also be coupled to host/buffer board 42 and stores a number of GPS interactive kid's learning programs. One or more levels of encryption may be used using, for example, the Data Encryption Standard (DES), double-DES, or any other conventional encryption technique. Interactive learning server 44 can be coupled to one or more displays 46 via an audio/video (A/V) bus. One or more controllers 22 can be coupled to network 19 including interactive learning controls and play controls for a car occupant to use during interactive learning. Each controller includes an interface, and preferably but not necessarily, each controller 22 is a multifunction controller.

Each learning station in vehicle 12 may be served by an interactive learning engine/server 44, and the vehicle occupant at the station may select an interactive learning program for retrieval by the host/buffer board 42 from interactive learning library 40 by selecting a game from a menu displayed on display 46 using a controller 22. The interactive learning program retrieved from library 40 is routed to the appropriate interactive learning engine, which decrypts and executes the interactive learning program, and provides the resulting A/V display information to display 46.

In a vehicle equipped with only one interactive learning capability (i.e., resident in the interactive learning server), computer 4 acts as a controller for selecting, turning on or off and/or remotely manipulating interactive learning. A vehicle may be equipped with more than one interactive learning capability. For example, a car may have the capability of a game console represented by the interactive learning server and an additional interactive learning capability represented by an emulator or transcompiler running on computer 4. In this case, if a user is playing an emulated video game, the game server (if used) merely acts as a path for the audio and video via an A/V bus.

Interactive learning library 40 and host/buffer board 42 can support multiple interactive learning engines. Interface logic multiplexes access to interactive learning library 40 among plural game engines and associated buffers. Interactive learning library 40 stores an interactive learning library comprising a number of different GPS based interactive learning programs. Interactive learning library 40 may be formatted into blocks (e.g., 1.5 GB each in one particular implementation). Each block may store a different interactive learning program.

Host buffer 42 and interactive learning server(s) 44 can provide any number of real time GPS interactive learning execution sessions simultaneously (e.g., up to a predetermined maximum determined by equipment capabilities) to allow multiple remote users to play GPS interactive learning programs simultaneously. Host buffer 42 can, for example, start two different execution sessions on two interactive learning servers 44 so each car occupant user can play the interactive learning programs simultaneously. If the car occupants indicate a desire to play against one another, the interactive learning server can support head-to-head play to control the same interactive learning and play against one another or otherwise participate in the same interactive learning experience.

GPS 18 can be coupled directly to computer 4. Computer 4 would receive position data from GPS 18 continuously. This position data could be used by learning library 40 to provide the user with a number of choices for interactive learning. It is further contemplated the interactive learning program could be personalized so the interactive learning system can speak to the child.

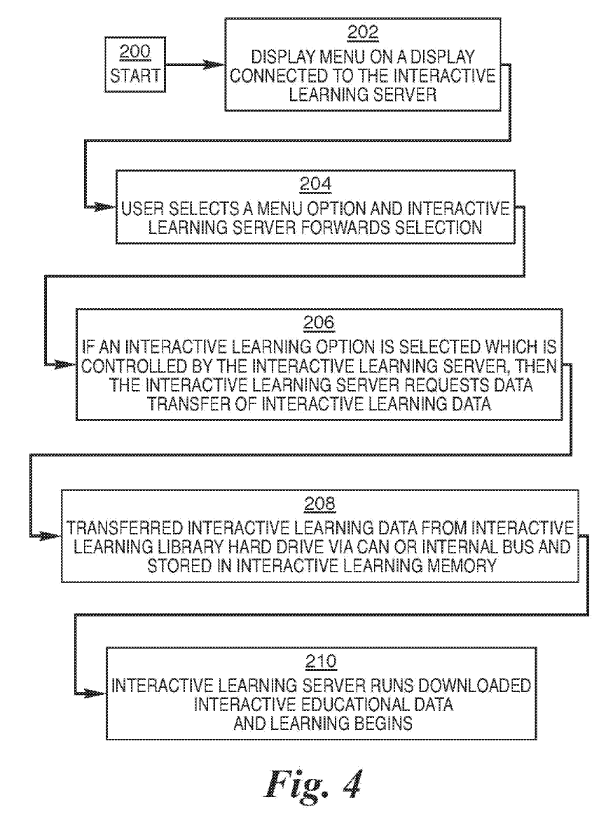

With reference to FIG. 4, a flow chart diagram for selecting and running an interactive GPS learning system in an embodiment of the present invention is shown. Program 200 for interactive learning in accordance with an embodiment of the car area network-based entertainment system where a buffer 42, an interactive learning server 44 and an interactive learning library 40 located in vehicle 12 are used. A menu is displayed on an interactive learning display 46 providing a car occupant with a number of consumer electronic device options and interactive learning options at state 202. The car occupant selects a menu option, and if the selected option relates to another consumer electronic device, interactive learning server 44 forwards the selection via CAN 50 to the selected option via the car area network at state 204. The selected option is then operated in accordance with the car occupant's selection.

If an interactive learning option is selected which is controlled by interactive learning server 44, then interactive learning server 44 requests transfer of interactive learning data from interactive learning library 40 via CAN 50 or via an internal bus coupling interactive learning server 44 and interactive learning library 40 at state 206. Interactive learning server 44 may be located internally or externally to computer 4. Interactive learning server 44 stores the transferred interactive learning data in memory 34 at state 208. Interactive learning server 44 can then run the selected interactive learning option using the stored interactive learning data file and interactive learning begins at state 210.

In another set of example embodiments, the car-based interactive learning system may use computer 4 as a virtual interactive learning platform to run PC type interactive learning programs and/or interactive learning platforms using an emulator or transcompiler. An emulation implementation is also advantageous when the car does not have an interactive learning server within vehicle 12, and the interactive learning server is external to vehicle 12.

In an emulation implementation for FIG. 3, computer 4 receives a interactive learning selection via network 19 and sends a request to an interactive learning server (which may be located internally or externally to vehicle 12) to retrieve the selected interactive learning file from interactive learning library 40 (which also may be located within vehicle 12, as shown, or externally to vehicle 12) and to send the selected interactive learning file to computer 4 over the car area network 19 for storage in memory 34. If computer 4 has not yet been adapted or transformed into a virtual interactive learning program, then an emulator or transcompiler application program must first be transferred from interactive learning server to computer memory 34. Once this is done, CPU 31 executes this application out of memory 34 and then identifies the user selected interactive multi-functional program. The user selected interactive multi-functional program is a data file which needs to be transferred from the interactive multi-functional server to memory 34. The interactive multi-functional file is a data file stored in memory 80, which is processed by the emulator or transcompiler application software stored in memory 90 to generate the audio and video and controller interactive multi-functional information which would be generated if the interactive multi-functional program were executed on its native hardware interactive learning platform.

The audio and video information generated by ROM 90 is provided via CAN 50 to the buffers(s) 42 and interactive multi-functional server(s) 44 which then provide audio and video information via an A/V bus to displays 46, 46′ and 46″. In this configuration, multiple displays are provided to permit multiple players to play the same interactive multi-functional program simultaneously, with each player having his/her own controller 22. Alternatively, the audio and video information may be provided directly from computer 4 to the display(s) via an A/V bus eliminating the need for buffer 42 and server 44. If the bandwidth is high enough to permit satisfactory interactive learning, digitally encoded audio and video information may be transported in digital form (e.g., MPEG format) from computer 4 to the host/buffer 42 via the CAN 50. This approach eliminates the need for including the interactive learning server(s) in the car and for an A/V bus to the display(s).

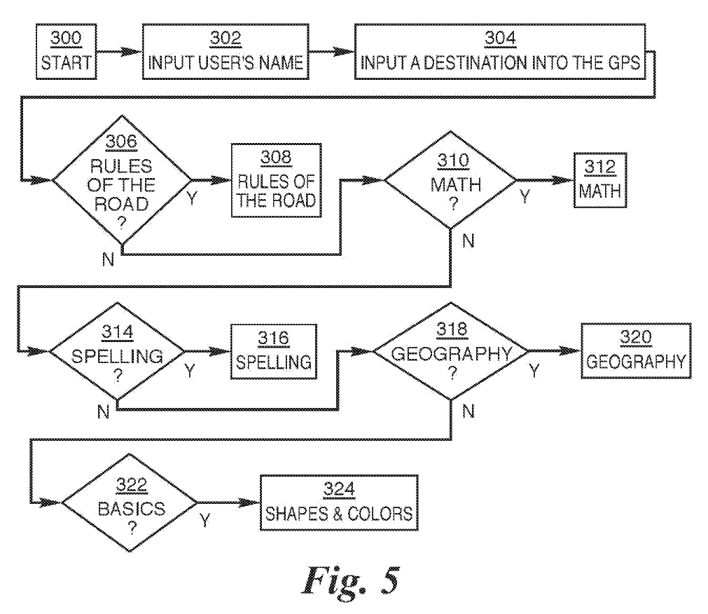

With reference to FIG. 5, a flow chart diagram for using an interactive GPS learning system in an embodiment of the present invention is shown. In operation interactive learning program 300 could implement all or some of the following features. At state 302 an operator could input the name(s) of the children or other uses who will be using interactive learning program 300. Thus, when the operator turns the ignition of vehicle 12, interactive GPS system 130 is personalized. GPS system 130 could even say hello to the user, for example, “Hello Brian, today we are going on an adventure!” The GPS character voice could be animated.

At state 304 the operator of GPS 18 could input a destination. It is contemplated the user could have the same GPS directional map as the main unit, but display 20 could be more colorful. In one embodiment, the user could select learning about the rules of the road at state 306. The user could be asked questions regarding the rules of the road. As left turns, right turns and U-turns come up the user could be asked to pick the correct arrow appearing on the interactive screen at state 308. A question asked, for example, could be “Which way is right?” The user could also be asked directional questions such as “Are we driving South or North?”

At state 310 the user could select mathematical questions regarding their journey. At state 312 the user could be asked questions such as “How many miles do we have left if we have traveled a certain distance?”

At state 314 the user could select spelling questions regarding their journey. At state 316 program 300 could ask the user “What is the name of this street and how do you spell it?”

At state 318 the user could select geography questions regarding their journey. At state 320 program 300 could ask the user “What City, State and Country are we in?” Program 300 could also ask about nearby landmarks. For example, if vehicle 12 was driving past the science museum the user could be informed about the multi-functional concepts available in the museum.

At state 322 the user could select to learn about the basics including shapes and colors. Program 300 could ask questions regarding colors at state 324. For example, “What color is the arrow on the screen? Or, What color is a stop sign?” The user could also be asked, “What shape is a stop sign? Or, What shape is the building to the right?”

If the user makes a mistake in answering a questions, there is no affect on GPS 18. Further, the levels can be adjusted to make the questions easier and harder. Program 300 could have various games with different characters, which could be interchangeable. The operator could purchase a different character and game and can upload it to computer 4.

The embodiments above allow a user to learn concepts of road dynamics, math, reading, colors, spelling and logic skills. The user can feel a sense of accomplishment and be occupied during long or short drives.

Thus, embodiments of the INTERACTIVE MULTI-FUNCTIONAL GPS SYSTEM are disclosed. One skilled in the art will appreciate the present teachings can be practiced with embodiments other than those disclosed. The disclosed embodiments are presented for functions of illustration and not limitation, and the present teachings are limited only by the claims follow.

What is claimed is:

1. An interactive learning apparatus, comprising:
a network disposed in a vehicle to enable communications between various devices in the vehicle;
a GPS device operably coupled to the network; and
a computer operably coupled to the network wherein the computer is adapted to control execution of interactive learning program based upon input from the GPS device.

2. The apparatus of claim 1, further comprising an existing vehicle electronics device for the purpose of supporting the interactive learning program.

3. The apparatus of claim 1, further comprising a network interface coupled to the computer for interfacing with the network.

4. The apparatus of claim 1, further comprising a user interface coupled to the network.

5. The apparatus of claim 1, further comprising a memory for storing code executable by the computer, the code supporting play of one or more interactive GPS learning program.

6. The apparatus of claim 1, further comprising an interactive learning server coupled to the network for supporting play of one or more interactive learning programs.

7. The apparatus of claim 1, further including a display device coupled to the network for displaying interactive learning GPS program information to a vehicle occupant.

8. An interactive learning apparatus for use in a vehicle, comprising:
a network disposed in a vehicle to enable communications between various devices in the vehicle;
a GPS unit operably coupled to the network for providing vehicle positioning data to various devices in the vehicle;
a computer operably coupled to the network which can receive GPS data and based upon this data implements interactive learning programs for a vehicle user; and
a display device coupled to the network for displaying interactive learning program information to a vehicle occupant in accordance with GPS location data provided by the GPS unit.

9. The apparatus of claim 8, further comprising existing consumer electronics device coupled to the network wherein the consumer electronics device is configured to function as a interactive learning platform to support GPS interactive learning program.

10. The apparatus of claim 8, further comprising a network interface for interfacing the computer with the network.

11. The apparatus of claim 8, further comprising a user interface coupled to the network.

12. The apparatus of claim 11, wherein the user interface can be part of the display device.

13. The apparatus of claim 8, further comprising a memory, coupled to the computer, for storing code executable by the computer and for storing at least temporarily one or more interactive learning programs.

14. The apparatus of claim 8, further comprising a multifunction controller for transmitting control information to the computer via the network to permit a vehicle occupant to interact with the interactive GPS learning program.

15. A method for interactive learning in a vehicle, the steps comprising:
using a network disposed in a vehicle to enable communications between various electronic devices in the vehicle;
receiving GPS data from a GPS device;
processing an interactive learning program based upon received GPS data;
displaying the interactive learning program to a vehicle occupant; and
receiving commands from the vehicle occupant directing the interactive leaning program.

16. The method of claim 15, further comprising the step of adapting one of the electronic devices to support interactive GPS learning programs.

17. The method of claim 15, further comprising the step of displaying a menu including interactive GPS learning options to a vehicle occupant.

18. The method of claim 17, further comprising the step of receiving over the network at the selected menu option; if the selected menu option is an interactive GPS learning program, providing the interactive learning program selection to the vehicle occupant.

19. The method of claim 15, further comprising the step of downloading an interactive GPS learning file corresponding to the interactive GPS learning selection over the network.

20. The method of claim 15, further comprising the step of executing executable code in a computer in order to run the selected interactive GPS learning program corresponding to an inputted GPS location of the vehicle.
